(19) United States
(12) Patent Application Publication
(10) Pub. No.: US 2025/0062403 A1
(43) Pub. Date: Feb. 20, 2025

(54) POLYMERIC FLUORINATED GEL ELECTROLYTE

(71) Applicant: GM GLOBAL TECHNOLOGY OPERATIONS LLC, Detroit, MI (US)

(72) Inventors: Zhe Li, Shanghai (CN); Haijing Liu, Shanghai (CN); Qili Su, Shanghai (CN)

(21) Appl. No.: 18/474,545

(22) Filed: Sep. 26, 2023

(30) Foreign Application Priority Data
Aug. 17, 2023 (CN) 202311041393.6

(51) Int. Cl. H01M 10/0565; H01M 10/0525

(52) U.S. Cl. CPC H01M 10/0565; H01M 10/0525; H01M 2300/0082

(57) ABSTRACT

A polymeric gel electrolyte for an electrochemical cell, such as a solid-state battery, is provided herein as well an electrochemical cell including the polymeric gel electrolyte. The polymeric gel electrolyte includes a lithium salt comprising sulfur and fluorine, a lithium salt comprising boron, a fluorinated plasticizer, a non-fluorinated plasticizer, and a polymeric host. A w/w ratio of the fluorinated plasticizer to the non-fluorinated plasticizer is 9:1 to 1:9.

### CROSS-REFERENCE TO RELATED APPLICATIONS

This application claims priority to Chinese Patent Application No. 202311041393.6, filed Aug. 17, 2023, and all the benefits accruing therefrom under 35 U.S.C. § 119, the contents of which in its entirety are herein incorporated by reference.

### INTRODUCTION

The subject disclosure relates to relates to batteries, for example solid-state batteries, including a polymeric gel electrolyte with improved room-temperature rate capability, low-temperature discharge, and high-temperature durability and methods for forming the same.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte layer may be disposed between the negative and positive electrodes. The electrolyte is suitable for conducting lithium ions between the electrodes and, like the two electrodes, may be in a solid form, a liquid form, or a solid-liquid hybrid form. In instances of solid-state batteries, which include a solid-state electrolyte layer disposed between the solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-flammable, so as to allow cells to be cycled under harsher conditions without experiencing diminished potential or thermal runaway, which can potentially occur with the use of liquid electrolytes. In addition, within solid-state batteries, interfacial contact between solid-state electrolyte particles and electrode active material particles can be poor. Introducing a gel polymer electrolytes into solid-state batteries can help build up favorable lithium ion conduction at an interface. However, conventional gel polymer electrolytes used in solid-state batteries may contribute to the formation of an unfavorable solid electrolyte interphase (SEI) layer on the anode, such as a graphite or silicon anode, thereby inhibiting lithium ion intercalation and deintercalation. As a result of this poor compatibility between the gel polymer electrolyte and anode, batteries that use such gel polymer electrolytes can experience poor performance across a range of temperatures, for example, poor room-temperature rate capability, poor low-temperature discharge, and poor high-temperature durability.

Accordingly, it is desirable to provide gel polymer electrolytes for high-performance batteries that improve room-temperature rate capability, low-temperature discharge, and high-temperature durability for improved battery performance in all climates.

### SUMMARY

In one exemplary embodiment, the present disclosure provides a polymeric gel electrolyte for an electrochemical cell. The polymeric gel electrolyte includes a lithium salt including sulfur and fluorine, a lithium salt including boron, a fluorinated plasticizer, a non-fluorinated plasticizer, and a polymeric host. A weight (w/w) ratio of the fluorinated plasticizer to the non-fluorinated plasticizer is 9:1 to 1:9.

In addition to one or more of the features described herein, the polymeric gel electrolyte may have one or more of the following satisfied: (i) a combination of the lithium salt including sulfur and fluorine and the lithium salt including boron may have a concentration of greater than or equal to about 1 mole per liter (molar (M)) to less than or equal to about 4 M; and (ii) each of the lithium salt including sulfur and fluorine and the lithium salt including boron has a concentration of greater than or equal to about 0.6 M to less than or equal to about 2 M.

In another exemplary embodiment, the lithium salt including sulfur and fluorine may include a lithium cation (Li⁺) and an anion selected from the group consisting of bis-trifluoromethanesulfonimide (TFSI⁻), bis(fluorosulfonyl)imide (FSI⁻), trifluoromethanesulfonate (triflate⁻) bis(pentafluoroethanesulfonyl)imide (BETI⁻), cyclo-difluoromethane-1,1-bis(sulfonyl)imide (DMSI⁻), cyclo-hexafluoropropane-1,1-bis(sulfonyl)imide (HPSI⁻), and a combination thereof; and the lithium salt including boron may include a lithium cation (Li⁺) and an anion selected from the group consisting of tetrafluoroborate (BF₄⁻), bis(oxaloto)borate (BOB⁻), tetracyanoborate (bison⁻), difluoro(oxalate)borate (DFOB⁻), bis(fluoromalonato)borate (BFMB⁻), and a combination thereof.

In yet another exemplary embodiment, the fluorinated plasticizer may include fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethylmethylcarbonate, 2,2-difluoroethy lethylethylcarbonate, 2,2-difluoroethylacetate, 2,2,2-trifluoroethylacetate, 1,1,2,2-tatrafluoroethyl 2,2,3,3-tetrafluoropropyl ether, or a combination thereof; and the non-fluorinated plasticizer may include γ-butyrolactone (GBL), propylene carbonate (PC), glycerol carbonate, vinylene carbonate, 1,2-buty lene carbonate, δ-valerolactone, succinonitrile, glutaronitrile adiponitrile, tetramethylene sulfone, ethyl methyl sulfone, vinyl sulfone, phenyl sulfone, benzyl sulfone, triethylene glycol dimethylether, tetraethylene glycol dimethylether, 1,3-dimethoxy propane, 1,4-dioxane, triethyl phosphate, trimethyl phosphate, or a combination thereof.

In yet another exemplary embodiment, the lithium salt including sulfur and fluorine may include lithium bis(trifluoromethanesulfonyl)imide (LiTFSI); the lithium salt including boron may include lithium tetrafluoroborate (LiBF₄); the fluorinated plasticizer may include fluoroethylene carbonate (FEC); the non-fluorinated plasticizer may include γ-butyrolactone (GBL); and the polymeric host may include polyvinylidene fluoride-hexafluoropropylene (PVDF-HFP).

In yet another exemplary embodiment, the polymeric host may be selected from the group consisting of: polyvinylidene fluoride (PVDF), polyvinylidene fluoride-hexafluoropropylene (PVDF-HFP), polyethylene oxide (PEO), poly(acrylic acid) (PAA), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

In yet another exemplary embodiment, the polymeric gel electrolyte may have one or more of the following satisfied: (i) a combination of the lithium salt including sulfur and fluorine and the lithium salt including boron may have a concentration of greater than or equal to about 1.2 M to less than or equal to about 4 M; (ii) each of the lithium salt including sulfur and fluorine and the lithium salt including boron has a concentration of greater than or equal to about 0.6 M to less than or equal to about 2 M; (iii) a w/w ratio of the fluorinated plasticizer to the non-fluorinated plasticizer is about 0.9:1 w/w to about 0.2:1 w/w; and (iv) the polymer host is present in an amount of 0.5 weight percent (wt. %) to about 40 wt. %.

In yet another exemplary embodiment, the polymeric gel electrolyte may have one or more of the following satisfied: (i) the lithium salt including sulfur and fluorine may include lithium bis(trifluoromethanesulfonyl)imide (LiTFSI); (ii) lithium salt including boron may include lithium tetrafluoroborate (LiBF₄); (iii) the fluorinated plasticizer may include fluoroethylene carbonate (FEC); (iv) the non-fluorinated plasticizer may include γ-butyrolactone (GBL); and (v) the polymeric host may include poly vinylidene fluoride-hexafluoropropylene (PVDF-HFP).

In yet another exemplary embodiment, the polymeric gel electrolyte may further include solid-state electrolyte particles.

In one exemplary embodiment, the present disclosure provides an electrochemical cell. The electrochemical cell includes a first electrode including a first electroactive material, a second electrode including a second electroactive material, and an electrolyte layer disposed between the first electrode and the second electrode. At least one of the first electrode, the second electrode, and the electrolyte layer may include a polymeric gel electrolyte. The polymeric gel electrolyte includes a lithium salt including sulfur and fluorine, a lithium salt including boron, a fluorinated plasticizer, a non-fluorinated plasticizer, and a polymeric host. A w/w ratio of the fluorinated plasticizer to the non-fluorinated plasticizer is 9:1 to 1:9.

In addition to one or more of the features described herein, wherein the electrolyte layer may include a plurality of solid-state electrolyte particles and the polymeric gel electrolyte at least partially fills void spaces between the solid-state electrolyte particles.

In another exemplary embodiment, the electrolyte layer may further include a separator, wherein the gel polymer electrolyte polymeric gel electrolyte at least partially fills void spaces in the polymeric separator.

In yet another exemplary embodiment, the first electroactive material may be selected from the group consisting of Li₍₁₊ₓ₎Mn₂O₄, where 0.1≤x≤1; LiMn₍₂₋ₓ₎NixO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn_{2 -x}FeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤ 1, 0<p<1, x+y+z+p=1 (NCMA); LiNiMnCoO₂; Li₂FeₓM₁₋ₓPO₄, where M is Mn and/or Ni, 0≤x≤1; LiMn₂O₄ (LMO); LiFeSiO₄; LiNi_{0.6} Mn_{0.2}Co_{0.2}O₂ (NMC622), LiMnO₂, LiNi_{0.5}, Mn1.5O₄, LiV₂(PO₄)₃, activated carbon, sulfur, and a combination thereof. The second electroactive material may include metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, iron sulfide (FeS), Li4TisO12, or a combination thereof.

In yet another exemplary embodiment, the polymeric gel electrolyte may have one or more of the following satisfied: (i) a combination of the lithium salt including sulfur and fluorine and the lithium salt including boron may have a concentration of greater than or equal to about 1 M to less than or equal to about 4 M; and (ii) each of the lithium salt including sulfur and fluorine and the lithium salt including boron has a concentration of greater than or equal to about 0.6 M to less than or equal to about 2 M.

In yet another exemplary embodiment, the lithium salt including sulfur and fluorine may include a lithium cation (Li⁺) and an anion selected from the group consisting of bis-trifluoromethanesulfonimide (TFSI⁻), bis(fluorosulfonyl)imide (FSI⁻), trifluoromethanesulfonate (triflate⁻) bis(pentafluoroethanesulfonyl)imide (BETI⁻), cyclo-difluoromethane-1,1-bis(sulfonyl)imide (DMSI⁻), cyclo-hexafluoropropane-1,1-bis(sulfonyl)imide (HPSI⁻), and a combination thereof; and the lithium salt including boron may include a lithium cation (Li⁺) and an anion selected from the group consisting of tetrafluoroborate (BF₄⁺), bis(oxalato)borate (BOB⁻), tetracyanoborate (bison⁻), difluoro(oxalate)borate (DFOB⁻), bis(fluoromalonato)borate (BFMB⁻), and a combination thereof.

In yet another exemplary embodiment, the fluorinated plasticizer may include fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethylmethylcarbonate, 2,2-difluoroethy lethylethylcarbonate, 2,2-difluoroethylacetate, 2,2,2-trifluoroethylacetate, 1,1,2,2-tatrafluoroethyl 2,2,3,3-tetrafluoropropyl ether, or a combination thereof; and the non-fluorinated plasticizer may include γ-butyrolactone (GBL), propylene carbonate (PC), glycerol carbonate, vinylene carbonate, 1,2-buty lene carbonate, δ-valerolactone, succinonitrile, glutaronitrile adiponitrile, tetramethylene sulfone, ethyl methyl sulfone, vinyl sulfone, phenyl sulfone, benzyl sulfone, triethylene glycol dimethylether, tetraethylene glycol dimethylether, 1,3-dimethoxy propane, 1,4-dioxane, triethyl phosphate, trimethyl phosphate, or a combination thereof.

In yet another exemplary embodiment, the lithium salt including sulfur and fluorine may include lithium bis(trifluoromethanesulfonyl)imide (LiTFSI); the lithium salt including boron may include lithium tetrafluoroborate (LiBF₄); the fluorinated plasticizer may include fluoroethylene carbonate (FEC); the non-fluorinated plasticizer may include γ-butyrolactone (GBL); and the polymeric host may include polyvinylidene fluoride-hexafluoropropylene (PVDF-HFP).

In yet another exemplary embodiment, the polymeric host may be selected from the group consisting of: polyvinylidene fluoride (PVDF), polyvinylidene fluoride-hexafluoropropylene (PVDF-HFP), polyethylene oxide (PEO), poly(acrylic acid) (PAA), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

In yet another exemplary embodiment, the polymeric gel electrolyte may have one or more of the following satisfied: (i) a combination of the lithium salt including sulfur and fluorine and the lithium salt including boron may have a concentration of greater than or equal to about 1.2 M to less than or equal to about 4 M; (ii) each of the lithium salt including sulfur and fluorine and the lithium salt including boron has a concentration of greater than or equal to about 0.6 M to less than or equal to about 2 M; (iii) a w/w ratio of the fluorinated plasticizer to the non-fluorinated plasticizer is about 0.9:1 w/w to about 0.2:1 w/w, and (iv) the polymer host is present in an amount of 0.5 wt. % to about 40 wt. %.

In yet another exemplary embodiment, the polymeric gel electrolyte may have one or more of the following satisfied: (i) the lithium salt including sulfur and fluorine may include lithium bis(trifluoromethanesulfonyl)imide (LiTFSI); (ii) the lithium salt including boron may include lithium tetrafluoroborate (LiBF₄); (iii) the fluorinated plasticizer may include fluoroethylene carbonate (FEC); (iv) the non-fluorinated plasticizer may include γ-butyrolactone (GBL); and (v) the polymeric host may include polyvinylidene fluoride-hexafluoropropylene (PVDF-HFP).

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates possible evolution of SEI layers on silicon resulting from a polymeric gel electrolyte including ethylene carbonate (EC) and GBL;

FIG. 2A is a schematic of an exemplary electrochemical battery cell;

FIG. 2B is a schematic of another exemplary electrochemical battery cell;

FIG. 3 is a graphical illustration demonstrating capacity retention for the battery cells of Comparative Examples 1 and 2 and Examples 1 and 2;

FIG. 4 is a graphical illustration demonstrating capacity retention for the battery cells of Comparative Examples 1 and 2 and Examples 1 and 2;

FIG. 5 is a graphical illustration demonstrating low-temperature cranking for the battery cells of Comparative Examples 1 and 2 and Examples 1 and 2;

FIG. 6 are scanning electron microscope (SEM) images of the silicon anode of Comparative Example 1 after testing at 45° C. for 100 cycles;

FIG. 7 are scanning electron microscope (SEM) images of the silicon anode of Comparative Example 2 after testing at 45° C. for 100 cycles;

FIG. 8 are scanning electron microscope (SEM) images of the silicon anode of Example 1 after testing at 45° C. for 100 cycles; and

FIG. 9 are scanning electron microscope (SEM) images of the silicon anode of Example 2 after testing at 45° C. for 100 cycles.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a polymeric gel electrolyte for solid-state batteries (SSBs), and methods of forming and using the same are disclosed. Solid-state batteries may include at least one solid component, for example, at least one solid electrode, but may also include semi-solid or gel, liquid, or gas components, in certain variations. Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

### I. Polymeric Gel Electrolyte

A polymeric gel electrolyte for use in an electrochemical cell, such as semi-solid and solid-state batteries, is provided herein. The polymeric gel electrolyte includes a lithium salt including sulfur and fluorine, a lithium salt including boron, a fluorinated plasticizer, a non-fluorinated plasticizer, and a polymeric host. A w/w ratio of the fluorinated plasticizer to the non-fluorinated plasticizer is 9:1 to 1:9.

In any embodiment, the lithium salt including sulfur and fluorine may include a lithium cation (Li⁺) and an anion selected from the group consisting of: bis-trifluoromethanesulfonimide (TFSI⁻), bis(fluorosulfonyl)imide (FSI⁻), trifluoromethanesulfonate (triflate⁻) bis(pentafluoroethanesul fonyl)imide (BETI⁻), cyclo-difluoromethane-1,1-bis(sulfonyl)imide (DMSI⁻), and cyclo-hexafluoropropane-1,1-bis(sulfonyl)imide (HPSI⁻); and the lithium salt including boron may include a lithium cation (Li⁺) and an anion selected from the group consisting of: tetrafluoroborate (BF4), bis(oxaloto)borate (BOB⁻), tetracyanoborate (bison⁻), difluoro(oxalate)borate (DFOB⁻), and bis(fluoromalonato)borate (BFMB⁻). For example, the lithium salt including sulfur and fluorine may be lithium bis(trifluoromethanesulfonyl)imide (LiTFSI) and the lithium salt including boron may be lithium tetrafluoroborate (LiBF₄).

In any embodiment, a combination of the lithium salt including sulfur and fluorine and the lithium salt including boron may be present in a concentration of greater than or equal to about 0.6 M, greater than or equal to about 0.8 M, greater than or equal to about 1 M, greater than or equal to about 1.2 M, greater than or equal to about 1.4 M, greater than or equal to about 1.6 M, greater than or equal to about 1.8 M, greater than or equal to about 2 M, less than or equal to about 4 M, less than or equal to about 3.5 M, less than or equal to about 3 M, or less than or equal to about 2.5 M; or from greater than or equal to about 0.6 M to less than or equal to about 4 M, greater than or equal to about 0.8 M to less than or equal to about 4 M, greater than or equal to about 1 M to less than or equal to about 4 M, greater than or equal to about 1.2 M to less than or equal to about 4 M, or greater than or equal to about 1.6 M to less than or equal to about 3 M. Additionally, each of the lithium salt including sulfur and fluorine and the lithium salt including boron independently may be present in a concentration of greater than or equal to about 0.6 M, greater than or equal to about 0.8 M, greater than or equal to about 1 M, less than or equal to about 2 M, less than or equal to about 1.8 M, less than or equal to about 1.6 M, less than or equal to about 1.4 M, or less than or equal to about 1.2 M; or from greater than or equal to about 0.6 M to less than or equal to about 2 M, greater than or equal to about 0.8 M to less than or equal to about 1.8 M, or greater than or equal to about 1 M to less than or equal to about 1.6 M. Concentration of each of the lithium salt including sulfur and fluorine and the lithium salt including boron is based on the mole number of the lithium salt including sulfur and fluorine and the lithium salt including boron per total volume of the lithium salt including sulfur and fluorine, the lithium salt including boron, the fluorinated plasticizer, and the non-fluorinated plasticizer. Without wishing to be bound by any theory, it is believed that a concentration of a combination of the lithium salt including sulfur and fluorine and the lithium salt including boron and/or each of the lithium salt including sulfur and fluorine and the lithium salt including boron in the polymeric gel electrolyte within the disclosed range may advantageously facilitate the desolvation process of lithium ions at an anode surface, for example, which can enhance high-temperature cyclability.

In any embodiment, the polymeric gel electrolyte may include a fluorinated plasticizer and a non-fluorinated plasticizer. Examples of fluorinated plasticizers include, but are not limited to, fluoroethylene carbonate (FEC), difluoroethy lene carbonate (DFEC) , trifluoropropylene carbonate (TFPC), methyl 2,2,2-trifluoroethyl carbonate, ethyl 2,2,2-trifluoroethyl carbonate, 2,2-difluoroethylmethylcarbonate, 2,2-difluoroethylethylethylcarbonate, 2,2-difluoroethylacetate, 2,2,2-trifluoroethylacetate, 1,1,2,2-tatrafluoroethyl 2,2,3,3-tetrafluoropropyl ether, and other fluorine-based linear solvents and fluorine-based cyclic solvents. Examples of non-fluorinated plasticizer include, but are not limited to, γ-butyrolactone (GBL), carbonate solvents (such as propylene carbonate (PC), glycerol carbonate, vinylene carbonate, and 1,2-butylene carbonate), lactones (such as δ-valerolactone), nitriles (such as succinonitrile, glutaronitrile and adiponitrile), sulfones (such as tetramethylene sulfone, ethyl methyl sulfone, vinyl sulfone, phenyl sulfone, and benzyl sulfone), ethers (such as triethylene glycol dimethylether (triglyme, G3), tetraethylene glycol dimethylether (tetraglyme, G4), 1,3-dimethoxy propane and 1,4-dioxane), and phosphates (such as triethyl phosphate and trimethyl phosphate). In any embodiment, the fluorinated plasticizer may be fluoroethylene carbonate (FEC) and the non-fluorinated plasticizer may be γ-butyrolactone (GBL).

Without wishing to be bound by any theory, it is believed that from a synergistic effect of the fluorinated plasticizer (e.g., fluoroethylene carbonate (FEC)) and the non-fluorinated plasticizer (e.g., γ-butyrolactone (GBL)), the polymeric gel electrolyte can enable a robust SEI on an electroactive material such as silicon (with environmental benignity, desirable potential (about 0.3 volts (V)), and high theoretical capacity (4200 milliamperes per gram (mAh/g) for Li_{4.4}Si)) with a high content of LiF and appropriate elasticity to enhance cell cyclability. For example, possible electroreduction of FEC is illustrated as follows

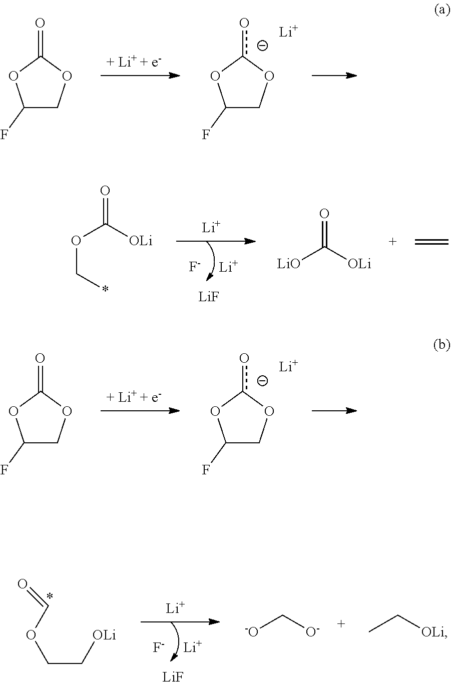

and possible electroreduction of GBL is illustrated as follows

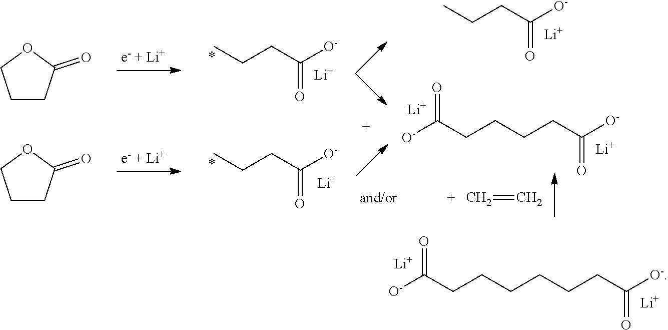

Reduction of FEC in the polymeric gel electrolyte may generate fluoride ions, which can lead to chemical attack of silicon-oxide surface passivation layers and formation of a kinetically stable SEI including predominately LiF. Reduction of GBL in the polymeric gel electrolyte may generate an organic oligomer species, which may provide elasticity to retain integrity of the SEI against mechanical damage during electroactive material (e.g., silicon) volume expansion and contraction. GBL, with a high flash point and a wide liquid temperature range, could empower an abuse-tolerable and all-climate SSB. After cycling, the SEI on the anode can include LiF in an amount of 10 to 50 wt. %, for example, 20 wt. %, and an organic oligomer species in an amount of 30 to 80 wt. %.

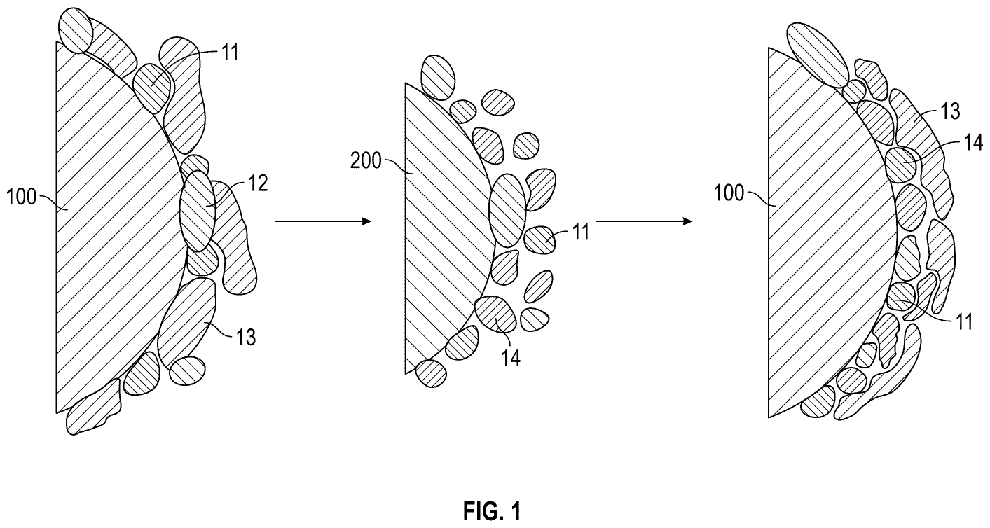

Regarding a polymeric gel electrolyte including EC and GBL, decomposition of EC/GBL in the polymeric gel electrolyte may result in formation of, for example, oligomer species, lithium ethylene dicarbonate (LEDC), and lithium carbonate (Li₂CO₃). Silica or lithium silicate on silicon may further catalyze the thermal decomposition of LEDC to generate Li₂CO₃, Li₂O, CO₂, ethylene, and lithium carboxylates, which are either soluble in polymeric gel electrolyte or gaseous, which may result in an unstable and ineffective SEI. Possible evolution of SEI layers on silicon resulting from a polymeric gel electrolyte including EC and GBL is illustrated in FIG. 1 and possible decomposition reactions of EC are illustrated as follows

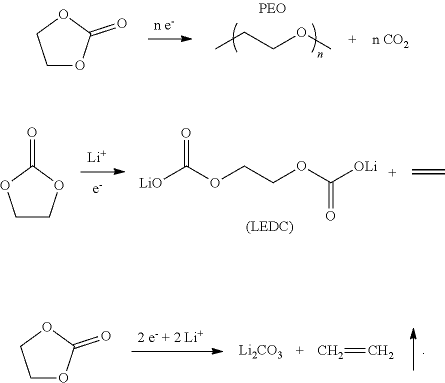

FIG. 1 shows de-lithiation followed by (re-) lithiation. In FIG. 1, LiₓSi is represented by reference numeral 100, Si is represented by reference numeral 200, LiF is represented by reference numeral 11, PEO is represented by reference numeral 12, LEDC is represented by reference numeral 13, and Li₂CO₃ is represented by reference numeral 14.

It has been discovered that the amount of each of the fluorinated plasticizer and the non-fluorinated plasticizer, for example, a weight ratio of the fluorinated plasticizer to the non-fluorinated plasticizer, can advantageously contribute to a battery having a balanced low-temperature discharge and high-temperature cyclability. For example, a weight (w/w) ratio of fluorinated plasticizer (e.g., fluoroethylene carbonate) to non-fluorinated plasticizer (e.g., γ-butyrolactone) can be about 3:7 w/w; or from about 9:1 w/w to about 1:9 w/w, about 0.9:1 w/w to about 0.2:1 w/w, or about 0.8:1w/w/to about 0.3:1 w/w.

Without wishing to be bound by any theory, it is believed that surface area of the electroactive material may affect the w/w ratio of fluorinated plasticizer to non-fluorinated plasticizer to provide desirable performance for a cell containing the disclosed polymeric gel electrolyte. For example, the w/w ratio of fluorinated plasticizer to non-fluorinated plasticizer to provide desirable performance for a cell containing the disclosed polymeric gel electrolyte may be greater for an electroactive material with a greater surface area as compared to the electroactive material with a lesser surface area (e.g., a nanosized particle as compared to a microsized particle).

Without wishing to be bound by any theory, it is believed that the combined amount of the lithium salt including sulfur and fluorine, the lithium salt including boron, the fluorinated plasticizer, and the non-fluorinated plasticizer may advantageously enable improved battery performance with respect to rate capability, low-temperature discharge, and high-temperature cyclability. Furthermore, the combination of the lithium salt including sulfur and fluorine (e.g., LiTFSI), the lithium salt including boron (e.g., LiB₄), the lithium salt including boron, the fluorinated plasticizer (FEC), and the non-fluorinated plasticizer (GBL) may synergistically contribute to the formation of a robust passivation layer on an anode surface which promotes the permeation of lithium cation solvates. In any embodiment, the lithium salt including sulfur and fluorine, the lithium salt including boron, the fluorinated plasticizer, and the non-fluorinated plasticizer may be present in an amount, based on total weight of the lithium salt including sulfur and fluorine, the lithium salt including boron, the fluorinated plasticizer, and the non-fluorinated plasticizer, and polymeric host, of from greater than or equal to about 60 wt. % to less than or equal to about 99.5 wt. %, or about 95 wt. %.

In any embodiment, the polymeric host may be selected from the group consisting of: polyvinylidene fluoride (PVDF), polyvinylidene fluoride-hexafluoropropylene (PVDF-HFP), polyethylene oxide (PEO), poly(acrylic acid) (PAA), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In any embodiment, the polymeric host may be polyvinylidene fluoride-hexafluoropropylene (PVDF-HFP). The polymeric host may be present in an amount, based on total weight of the polymeric gel electrolyte composition, of greater than or equal to about 0.5 wt. %, greater than or equal to about 1 wt. %, greater than or equal to about 2.5 wt. %, greater than or equal to about 5 wt. %, greater than or equal to about 10 wt. %, greater than or equal to about 15 wt. %, less than or equal to about 40 wt. %, less than or equal to about 35 wt. %, less than or equal to about 30 wt. %, less than or equal to about 25 wt. %, or less than or equal to about 20 wt. %; or from greater than or equal to about 0.5 wt. % to less than or equal to about 40 wt. %, greater than or equal to about 1 wt. % to less than or equal to about 30 wt. %, greater than or equal to about 2.5 wt. % to less than or equal to about 25 wt. %, greater than or equal to about 5 wt. % to less than or equal to about 20 wt. %.

In various aspects, the polymeric gel electrolyte can include a combination of one or more of the following: (i) a combination of the lithium salt including sulfur and fluorine and the lithium salt including boron has a concentration of greater than or equal to about 1.2 M to less than or equal to about 4 M; (ii) each of the lithium salt including sulfur and fluorine and the lithium salt including boron has a concentration of greater than or equal to about 0.6 M to less than or equal to about 2 M; (iii) the w/w ratio of the fluorinated plasticizer to the non-fluorinated plasticizer is about 0.9:1 w/w to about 0.2:1 w/w; and (iv) the polymer host is present in an amount of 0.5 wt. % to about 40 wt. %, based on total weight of the polymeric gel electrolyte. Additionally or alternatively, the polymeric gel electrolyte can include a combination of one or more of the following: (i) the lithium salt including sulfur and fluorine comprises lithium bis(trifluoromethanesulfonyl)imide (LiTFSI); (ii) the lithium salt including boron comprises lithium tetrafluoroborate (LiBF₄); (iii) the fluorinated plasticizer comprises fluoroethylene carbonate (FEC); (iv) the non-fluorinated plasticizer comprises γ-butyrolactone (GBL); and (v) the polymeric host comprises polyvinylidene fluoride-hexafluoropropylene (PVDF-HFP).

Additionally or alternatively, the polymeric gel electrolyte may further include solid-state electrolyte particles dispersed or distributed therein. The solid-state electrolyte particles may have an average particle diameter greater than or equal to about 0.02 micrometers (μm) to less than or equal to about 20 μm, optionally greater than or equal to about 0.1 μm to less than or equal to about 10 μm, and in certain aspects, optionally greater than or equal to about 0.1 μm to less than or equal to about 1 μm.

In any embodiment, the solid-state electrolyte particles may comprise one or more oxide-based particles, sulfide-based particles, metal-doped or aliovalent-substituted oxide particles, inactive oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La For example, in certain variations, the NASICON-type oxides may be selected from the group consisting of: Li₁₊ₓAlₓGe₂₋ₓ(PO₄)₃ (LAGP) (where 0≤x≤2), Li₁₄Al_{0.4}Ti_{1.6} (PO₄)₃, Li_{1.3}Al_{0.3} Ti_{1.7} (PO₄)₃, LiTi₂ (PO₄)₃, LiGeTi(PO₄)₃, LiGe₂(PO₄)₃, LiHf₂ (PO₄)₃, and combinations thereof. The Perovskite-type ceramics may be selected from the group consisting of: Li_{3.3} La_{0.53} TiO₃, LiSr_{1.65}Zr_{1.3}Ta_{1.7}O₉, Li_{7x-y}Sr₁₋ₓTa_{y}Zr_{1-y}O₃(where x=0.75y and 0.60<y<0.75), Li_{3/8}Sr_{7/16}Nb_{3/4}Zr_{1/4}O₃, Li₃ₓLa_{(2/3-x)}TIO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{y}P₃O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S-P₂S₅ systems (such as, Li₃PS₄, Li₇P₃S₁₁, and Li_{9.6}P₃S₁₂), Li₇S-SnS₂ systems (such as, Li₄SnS₄), Li₇S-SiS₂ systems, Li₇S-GeS₂ systems, Li₇S-B₂S₃ systems, Li₇S-GazS₃ system, Li₇S-P₂S₃ systems, Li₇S-Al₂S₃ systems, Li₃₄Si_{0.4}P_{0.6}S+, LinoGeP₂S_{11.700.3}, lithium argyrodite Li₆PS₅X (where X is one of Cl, Br, and I). Example pseudoternary sulfide systems include Li₂O-Li₂S-P₂S₅ systems, Li₇S-P₂S₅-P₂O₅ systems, Li₇S-P₂Ss-GeS₂ systems (such as, Li_{3.25}Ge_{0.25}P_{0.75}S₄ (thio-LISICON) and Li₁₀GeP₂S₁₂ (LGPS)), Li₇S-P₂S₅-LiX systems (where X is one of F, Cl, Br, and I) (such as, Li₆PS₅Br, Li₆PS₅Cl, L₇P₂S₈I, and Li₄PS₄I), Li₇S-As₂S₅-SnS₂ systems (such as, Li_{3.833}Sn_{0.833}As_{0.166}S₄), Li₇S-P₂S₅-Al₂S₃ systems, Li₇S-LiX-SiS₂ systems (where X is one of F, Cl, Br, and I), 0.4LiI·0.6Li₄SnS₄, and LinSi₂PS₁₂. Example pseudoquaternary sulfide systems include Li₇O-Li₂S-P₂S₅-P₂Os₅ systems, Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.1.9}S₁₂, Li₁₀ (Si_{0.5}Ge_{0.5}) P₂S₁₂, Li₁₀(Ge_{0.5}Sne_{0.5}) P₂S₁₂, Li₁o (Si_{0.5}Sn_{0.5}) P₂S₁₂, Li₇P_{2.9}Mn_{0.1}S_{10.710.3}, Li_{3.833}Sn_{0.833}As_{0.166}S₄, LiI-Li₄SnS₄, Li₄SnS₄, and Li_{10.35}[Sn_{0.27}Si_{1.08}] P_{1.65}S₁₂.

In certain variations, the inactive oxide particles may include, for example only, SiO₂, Al₂O₃, TiO₂, ZrO₂, and combinations thereof; the nitride-based particles may include, for example only, Li₃N, Li₇PN₄, LiSi₂N₃, and combinations thereof; the hydride-based particles may include, for example only, LiBH₄, LiBH₄-LiX (where X=Cl, Br, or I), LiNH₂, Li₂NH, LiBH₄-LiNH₂, Li₃AlH₆, and combinations thereof: the halide-based particles may include, for example only, LiI, Li₃InCl₆, Li₂CdCl₄, Li₂MgCl₄, LiCdI₄, Li₇ZnI₄, Li₃OCl, Li₃YCl₆, Li₃YBr₆, and combinations thereof: and the borate-based particles may include, for example only, Li₇B₄O₇, Li₂O-B₂O₃-P₂O₅, and combinations thereof.

Although not illustrated, the skilled artisan will recognize that in certain instances, one or more binder particles (also referred to herein as polymeric binders) may be mixed with the solid-state electrolyte particles. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

The polymeric gel electrolyte may be prepared by admixing the lithium salt including sulfur and fluorine, the lithium salt including boron, the fluorinated plasticizer, the non-fluorinated plasticizer,, and polymeric host, with a suitable solvent to form a gel precursor solution. Suitable solvents include, but are not limited to, various alkyl carbonates, such as linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), chain structure ethers (e.g., 1,2-dimethoxyethane, 1-2-diethoxyethane, ethoxymethoxyethane), and cyclic ethers (e.g., tetrahydrofuran, 2-methyltetrahydrofuran), 1,3-dioxolane). The gel precursor solution may also optionally include solid-state electrolyte particles as described. The gel precursor solution may be applied to one or more of an anode, a cathode, and porous separator/membrane and infiltrate pores of the anode, cathode, and/or porous separator/membrane. Following application, the gel precursor solution may be volatilized by any suitable method (e.g., drying at a suitable temperature (e.g., ˜25° C.) for a suitable amount of time (e.g., ˜1 hour)) to remove the solvent and form the polymeric gel electrolyte.

### II. Electrochemical Cell

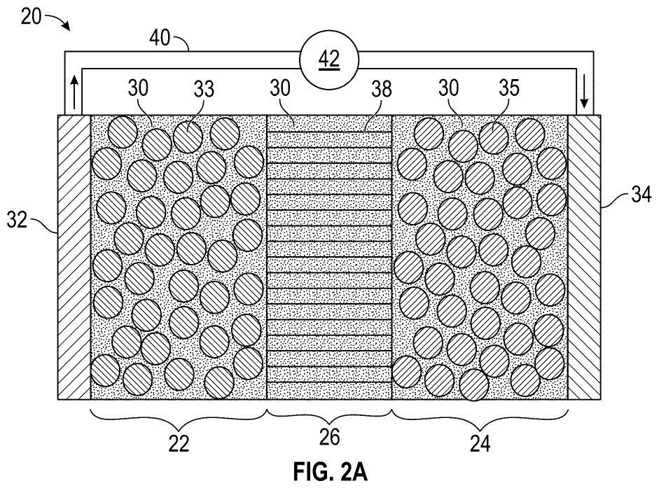

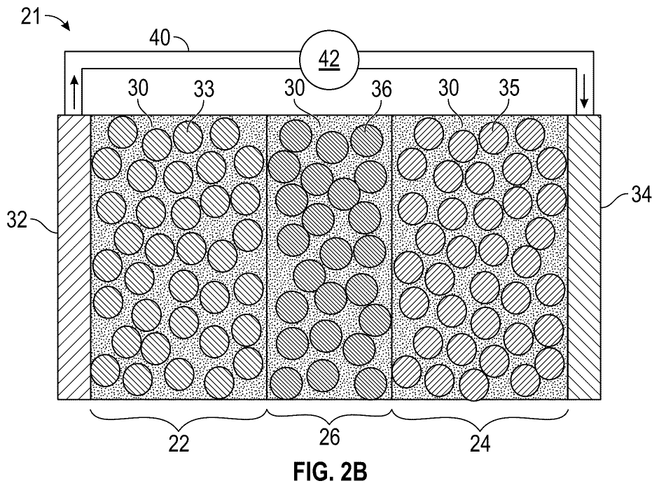

An electrochemical cell, such as a semi-solid or solid-state battery, including the polymeric gel electrolyte as described herein is provided herein. An exemplary and schematic illustration of a solid-state electrochemical cell unit (also referred to as a “solid-state battery” and/or “battery”) 20 that cycles lithium ions is shown in FIGS. 2A and 2B. The battery 20 includes a negative electrode 22 (also referred to as a negative electrode layer 22), a positive electrode 24 (also referred to as a positive electrode layer 24), and an electrolyte layer 26 disposed between the two electrodes 22, 24. The electrolyte layer 26 may be a solid-state or semi-solid state separating layer including a polymeric gel electrolyte 30 as described herein, for example, distributed on and within a porous separator 38 that physically separates the negative electrode 22 from the positive electrode 24. Thus, the space between the negative electrode 22 and positive electrode 24 can be filled with the polymeric gel electrolyte 30. If there are pores inside the negative electrode 22 and positive electrode 24, the pores may also be filled with the polymeric gel electrolyte 30. The polymeric gel electrolyte 30 can impregnate, infiltrate, or wet the surfaces of and fill the pores of each of the negative electrode 22, the positive electrode 24, and a porous separator 38. Additionally or alternatively, as shown in FIG. 2B, the electrolyte layer 26 may include a plurality of solid-state electrolyte particles 36 as described herein. A negative electrode current collector 32 may be positioned at or near the negative electrode, 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34). Each of the negative electrode 22, the positive electrode 24, and the separator 38 may further comprise the polymeric gel electrolyte 30 capable of conducting lithium ions. The separator 38 operates as both an electrical insulator and a mechanical support, by being sandwiched between the negative electrode 22 and the positive electrode 24 to prevent physical contact and thus, the occurrence of a short circuit. The separator 38, in addition to providing a physical barrier between the two electrodes 22, 24, can provide a minimal resistance path for internal passage of lithium ions (and related anions) for facilitating functioning of the battery 20. The separator 38 also contains the polymeric gel electrolyte 30 in a network of open pores during the cycling of lithium ions, to facilitate functioning of the battery 20.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte layer 26 towards the positive electrode 24. The electrons flow through the external circuit 40 and the lithium ions migrate across the electrolyte layer 26 to form intercalated lithium at the positive electrode 24. The electric current passing through the external circuit 40 can be harnessed and directed through the load device 42 until the inserted lithium in the negative electrode 22 is depleted and the capacity of the lithium ion battery 20 is diminished.

The lithium ion battery 20 can be charged or re-powered/re-energized at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte layer 26 back towards the negative electrode 22, reunite at the negative electrode 22 and replenish it with inserted lithium for consumption during the next battery discharge event. As such, a complete discharging event followed by a complete charging event is considered to be a cycle, where lithium ions are cycled between the positive electrode 24 and the negative electrode 22. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel Connected Elementary Cell Core (“PECC”).

Furthermore, the battery 20 can include a variety of other components that while not depicted here are nonetheless known to those of skill in the art. For instance, the lithium ion battery 20 may include a casing, gaskets, terminal caps, tabs, battery terminals, and any other conventional components or materials that may be situated within the battery 20, including between or around the negative electrode 22, the positive electrode 24, and/or the electrolyte layer 26, by way of non-limiting example.

As noted above, the size and shape of the lithium ion battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium ion cells or batteries to produce a greater voltage output and power density if it is required by the load device 42.

Accordingly, the battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 20 for purposes of storing energy.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

### A. Positive Electrode

The positive electrode 24 may be formed from a first electroactive material that can sufficiently undergo lithium intercalation and deintercalation while functioning as the positive terminal of the battery 20. It is contemplated herein that the first electroactive material may be in particle form and may have a round geometry or an axial geometry. The term “axial geometry” refers to particles generally having a rod, fibrous, or otherwise cylindrical shape having an evident long or elongated axis. Generally, an aspect ratio (AR) for cylindrical shapes (e.g., a fiber or rod) is defined as AR=L/D where L is the length of the longest axis and D is the diameter of the cylinder or fiber. Exemplary axial-geometry electroactive material particles suitable for use in the present disclosure may have high aspect ratios, ranging from about 10 to about 5,000, for example. In certain variations, the first electroactive material particles having an axial-geometry include fibers, wires, flakes, whiskers, filaments, tubes, rods, and the like. The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

The positive electrode 24 may be in the form of a layer having a thickness greater than or equal to about 1 μm to less than or equal to about 1,000 μm, optionally greater than or equal to about 5 μm to less than or equal to about 400 μm, and in certain aspects, optionally greater than or equal to about 10 μm to less than or equal to about 300 μm. In certain variations, the positive electrode 24 may be defined by a plurality of positive electroactive particles 35, for example, comprising the first electroactive material. The positive electroactive particles 35 may have an average particle diameter greater than or equal to about 0.01 μm to less than or equal to about 50 μm, and in certain aspects, optionally greater than or equal to about 1 μm to less than or equal to about 20 μm. The positive electrode 24 may also include a polymeric binder material to structurally fortify the lithium-based active material and an electrically conductive material.

One exemplary common class of known materials that can be used to form the positive electrode 24 includes layered lithium transitional metal oxides. For example, in certain embodiments, the positive electrode layer 24 may comprise Li₍₁₊ₓ₎Mn₂O₄, where 0.1≤x≤1; LiMn₂₋ₓ₎NiₓO₄, where 0≤x≤0.5; LiCoO₂; Li(NiₓMn_{y}Co_{z}) O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ) O₂, where 0≤x≤1, 0≤y≤1, 0≤z≤1, 0≤p≤1, x+y+z+p=1 (NCMA); LiNiMnCoO₂; Li₂FeₓM₁₋ₓPO₄ (M=Mn and/or Ni, 0≤x≤1); LiMn₂O₄ (LMO); LiFeSiO₄; LiNi_{0.6}Mn_{0.2}Co_{0.2}O₂ (NMC622), LiMnO₂, LiNi_{0.5}, Mn_{1.5}O₄, LiV₂(PO₄)₃, activated carbon, sulfur (e.g., greater than 60 wt. % based on total weight of the positive electrode), or combinations thereof. In certain aspects, the positive electroactive particles 35 may be coated (for example, by LiNbO₃ and/or Al₂O₃) and/or the positive electroactive material may be doped (for example, by aluminum and/or magnesium).

Although not illustrated, in certain variations, the positive electrode 24 can optionally include an electrically conductive material and/or a polymeric binder as described herein. For example, the positive electroactive particles 35 (may be optionally intermingled with one or more electrically conductive materials (not shown) that provide an electron conduction path and/or at least one polymeric binder material (not shown) that improves the structural integrity of the positive electrode 24.

Examples of electrically conductive material include, but are not limited to, carbon black (such as, Super P), graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GaInSn), a conductive polymer (e.g., include polyaniline, polythiophene, polyacetylene, polypyrrole, and the like) and combinations thereof. As used herein, the term “graphene nanoplatelet” refers to a nanoplate or stack of graphene layers. Such electrically conductive material in particle form may have a round geometry or an axial geometry as described above.

Examples of suitable polymeric binders, include but are not limited to, polyvinylidene difluoride (PVDF), polyvinylidene fluoride-hexafluoropropylene (PVDF-HFP), polytetrafluoroethylene (PTFE), ethylene propylene diene monomer (EPDM) rubber, carboxymethyl cellulose (CMC), a nitrile butadiene rubber (NBR), styrene-butadiene rubber (SBR) styrene ethylene butylene styrene copolymer (SEBS), lithium polyacrylate (LiPAA), sodium polyacrylate (NaPAA), poly(acrylic acid) PAA, polyimide, polyamide, sodium alginate, lithium alginate, and combinations thereof. In some embodiments, the polymeric binder may be a non-aqueous solvent-based polymer or an aqueous-based polymer. The first electroactive material may be intermingled with the electrically conductive material and/or at least one polymeric binder. For example, the first electroactive material and optional electrically conducting materials may be slurry cast with such binders and applied to a current collector.

In any embodiment, the first electroactive material may be present in the positive electrode 24 in an amount, based on total weight of the positive electrode, of greater than or equal to about 50 wt. %, greater than or equal to about 60 wt. %, greater than or equal to about 70 wt. %, greater than or equal to about 80 wt. %, greater than or equal to about 90 wt. %, greater than or equal to about 95 wt. %, or about 99 wt. %; or from about 50 wt. % to about 99 wt. %, about 70 wt. % to about 99 wt. %, or about 90 wt. % to about 99 wt. %.

Additionally or alternatively, the electrically conductive material and the polymeric binder each may be independently present in the positive electrode in an amount, based on total weight of the positive electrode from about 0.5 wt. % to about 20 wt. %, about 1 wt. % to about 15 wt. %, or about 1 wt. % to about 10 wt. %.

Although not illustrated, in certain variations, the positive electrode 24 can optionally include a solid-state electrolyte particle as described herein. The solid-state electrolyte particle may comprise one or more oxide-based particles, sulfide-based particles, metal-doped or aliovalent-substituted oxide particles, inactive oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn (GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′ (PO₄)₃, where M and M′ are independently selected from Al, Ge, Ti, Sn, Hf, Zr, and La For example, in certain variations, the NASICON-type oxides may be selected from the group consisting of: Li₁₊ₓAlGe₂₋ₓ(PO₄)₃ (LAGP) (where 0≤x≤2), Li_{1.4}Al_{0.4}Ti_{1.6} (PO₄)₃, Li_{1.3}Al_{0.3} Ti_{1.7} (PO₄)₃, LiTi₂ (PO₄)₃, LiGeTi(PO₄)₃, LiGe_{z}(PO₄)₃, LiHf₂(PO₄)₃, and combinations thereof. The Perovskite-type ceramics may be selected from the group consisting of: Li_{3.3}La_{0.53} TiO₃, LiSr_{1.65}Zr_{1.3}Ta_{1.7}O₉, Li_{7x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₇S-P₂S₅ systems (such as, Li₃PS₄, Li₇P₃S₁₁, and Li_{9.6}P₃S₁₂), Li₇S-SnS₂ systems (such as, Li₄SnS₄), Li₇S-SiS₂ systems, Li₇S-GeS₂ systems, Li₇S-B₂S₃ systems, Li₇S-GazS₃system, Li₇S-P₂S; systems, Li₇S-Al₂S₃ systems, Li₃₄Si_{0.4}P_{0.6}S₄, Li₁₀GeP₂S_{11.700.3}, lithium argyrodite Li₆PS₅X (where X is one of Cl, Br, and I). Example pseudoternary sulfide systems include Li₇O-Li₇S-P₂S₅systems, Li₇S-P₂S₅-P₂O₅ systems, Li₇S-P₂S₅-GeS₂ systems (such as, Li_{3.25}Ge_{0.25}P_{0.75}S₄ (thio-LISICON) and Li₁₀GeP₂S₁₂(LGPS)), Li₇S-P₂S₅-LiX systems (where X is one of F, Cl, Br, and I) (such as, Li₆PS₅Br, Li₆PS₅Cl, L₇P₂S₈I, and Li₄PS₄I), Li₇S-As₂S₅-SnS₂ systems (such as, Li_{3.833}Sn_{0.833}As_{0.166}S₄), Li₂S-P₂S₅-Al₂S₃ systems, Li₇S-LiX-SiS₂ systems (where X is one of F, Cl, Br, and I), 0.4LiI·0.6Li,SnS₄, and LinSi₂PS₁₂. Example pseudoquaternary sulfide systems include Li₂O-Li₂S-P₂S₅-P₂O₅ systems, Li_{9.54}S_{11.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂. Li_{9.81}Sn_{0.81}P_{2.1.9}S₁₂, Li₁₀(Si_{0.5}Ge_{0.5}) P₂S₁₂, Li₁₀ (Ge_{0.5}Sne_{0.5}) P₂S₁₂, Li₁₀ (Si_{0.5}Sn_{0.5}) P₂S₁₂, Li₇P_{2.9}Mn_{0.1}S_{10.710.3}, Li_{3.833}Sn_{0.833}As_{0.166}S₄, LiI-Li₄SnS₄, Lia₄SnS₄, and Li_{10.35 [}Sn_{0.27}Si_{1.08]} P_{1.65}S₁₂.

In certain variations, the inactive oxide particles may include, for example only, SiO₂, Al₂O₃, TiO₂, ZrO₂, and combinations thereof; the nitride-based particles may include, for example only, Li₃N, Li₇PN₄, LiSi₂N₃, and combinations thereof; the hydride-based particles may include, for example only, LiBH₄, LiBH₄-LiX (where X=Cl, Br, or I), LiNH₂, Li₇NH, LiBH₄-LINH₂, Li₃AlH₆, and combinations thereof; the halide-based particles may include, for example only, LiI, Li₃InCl₆, Li₂CdCl₄, Li₂MgCl₄, LiCdI₄, Li₇ZnI₄, Li₃OCl, Li₃YCl₆, Li₃YBr₆, and combinations thereof; and the borate-based particles may include, for example only, Li₂B₄O₇, Li₇O-B₂O₃-P₂O₅, and combinations thereof.

Additionally or alternatively, the solid-state electrolyte particle may be independently present in the positive electrode in an amount, based on total weight of the positive electrode from about 0.5 wt. % to about 20 wt. %, about 1 wt. % to about 15 wt. %, or about 1 wt. % to about 10 wt. %. In certain variations, the positive electrode may comprise 30 wt. % to 98 wt. % of the first electroactive material, 0wt. % to 50 wt. % of the solid-state electrolyte particles, 0 wt. % to 30 wt. % of the electrically conductive material, 0 wt. % 20 wt. % of the polymeric binder, and 0 wt. % to 30 wt. % of the polymeric gel electrolyte.

### B. Negative Electrode

The negative electrode 22 includes a second electroactive material as a lithium host material capable of functioning as a negative terminal of a lithium ion battery. The negative electrode 22 may be in the form of a layer having a thickness greater than or equal to about 1 μm to less than or equal to about 1,000 μm, optionally greater than or equal to about 5 μm to less than or equal to about 400 μm, and in certain aspects, optionally greater than or equal to about 10 μm to less than or equal to about 300 μm. In certain variations, the negative electrode 22 may be defined by a plurality of negative electroactive particles 33, for example, comprising the second electroactive material. The negative electroactive particles 33 may have an average particle diameter greater than or equal to about 0.01 μm to less than or equal to about 50 μm, and in certain aspects, optionally greater than or equal to about 1 μm to less than or equal to about 20 μm.

The second electroactive material may be formed from or comprise may comprise one or more carbonaceous negative electroactive materials, such as graphite, mesocarbon microbeads (MCMB), graphite carbon fiber, expanded graphite, soft carbon, hard carbon, nature graphite, graphene, or carbon nanotubes (CNTs). Additionally or alternatively, the second electroactive material may comprise a lithium alloy, such as, but not limited to, lithium silicon alloy, a lithium aluminum alloy, a lithium indium alloy, a lithium tin alloy, or combinations thereof. The negative electrode 22 may optionally further include one or more of silicon, tin oxide, aluminum, indium, zinc, germanium, silicon oxide, titanium oxide, lithium titanate, iron sulfide (FeS), Li₄Ti₅O₁₂ and combinations thereof, for example, silicon mixed with graphite. Non-limiting examples of silicon-containing electroactive materials include silicon (amorphous or crystalline), or silicon containing binary and ternary alloys, such as Si-Sn, SiSnFe, SiSnAl, SiFeCo, and the like. In any embodiment, the second electroactive material may be silicon. In other variations, the negative electrode 22 may be a metal film or foil, such as a lithium metal film or lithium-containing foil. The second electroactive material may be in particle form and may have a round geometry or an axial geometry as described herein.

Although not illustrated, in certain variations, the negative electrode 22 can optionally include an electrically conductive material and/or a polymeric binder as described herein. For example, the negative electroactive particles 33 (may be optionally intermingled with one or more electrically conductive materials (not shown) that provide an electron conduction path and/or at least one polymeric binder material (not shown) that improves the structural integrity of the negative electrode 22.

Examples of electrically conductive material include, but are not limited to, carbon black (such as, Super P), acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GaInSn), a conductive polymer (e.g., include polyaniline, polythiophene, polyacetylene, polypyrrole, and the like) and combinations thereof. Such electrically conductive material in particle form may have a round geometry or an axial geometry as described above.

Examples of suitable polymeric binders, include but are not limited to, polyvinylidene difluoride (PVDF), polyvinylidene fluoride-hexafluoropropylene (PVDF-HFP), polytetrafluoroethylene (PTFE), ethylene propylene diene monomer (EPDM) rubber, carboxymethyl cellulose (CMC), a nitrile butadiene rubber (NBR), styrene-butadiene rubber (SBR) styrene ethylene butylene styrene copolymer (SEBS), lithium polyacrylate (LiPAA), sodium polyacrylate (NaPAA), poly(acrylic acid) PAA, polyimide, polyamide, sodium alginate, lithium alginate, and combinations thereof. In some embodiments, the polymeric binder may be a non-aqueous solvent-based polymer or an aqueous-based polymer. In particular, the polymeric binder may be a non-aqueous solvent-based polymer that can demonstrate less capacity fade, provide a more robust mechanical network and improved mechanical properties to handle silicon particle expansion more effectively, and possess good chemical and thermal resistance. For example, the polymeric binder may include polyimide, polyamide, polyacrylonitrile, polyacrylic acid, a salt (e.g., potassium, sodium, lithium) of polyacrylic acid, polyacrylamide, polyvinyl alcohol, carboxymethyl cellulose, or a combination thereof. The first electroactive material may be intermingled with the electrically conductive material and/or at least one polymeric binder. For example, the first electroactive material and optional electrically conducting materials may be slurry cast with such binders and applied to a current collector.

In various aspects, the second electroactive material may be present in the negative electrode 22 in an amount, based on total weight of the negative electrode from about 70 wt. % to about 100 wt. %, about 70 wt. % to about 98 wt. %, about 70 wt. % to about 95 wt. %, about 80 wt. % to about 95 wt. %. Additionally or alternatively, the electrically conductive material and the polymeric binder each may be independently present in the negative electrode in an amount, based on total weight of the negative electrode from about 0.5 wt. % to about 30 wt. %, about 1 wt. % to about 25 wt. %, about 1 wt. % to about 20 wt. %, about 1 wt. % to about 10 wt. %, about 3 wt. % to about 20 wt. %, or about 5 wt. % to about 15 wt. %. In certain variations, the negative electrode may comprise 30 wt. % to 98 wt. % of the second electroactive material, 0 wt. % to 50 wt. % of solid-state electrolyte particles, 0 wt. % to 30 wt. % of the electrically conductive material, 0 wt. % 20 wt. % of the polymeric binder, and 0 wt. % to 30 wt. % of the polymeric gel electrolyte.

Although not illustrated, in certain variations, the negative electrode 22 can optionally include a solid-state electrolyte particle as described herein. The solid-state electrolyte particle may comprise one or more oxide-based particles, sulfide-based particles, metal-doped or aliovalent-substituted oxide particles, inactive oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3} La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn (GeO₄)₄, Li₃₊x (P₁₋ₓSiₓ)O₄ (where 0<x<1), Li₃₊ₓGeₓV₁₋ₓO₄ (where 0<x<1), and combinations thereof. The NASICON-type oxides may be defined by LiMM′ (PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti(PO₄)₃, Li_{1.3}Al_{0.3} Ti_{1.7}(PO₄)₃, LiTi₂ (PO₄)₃, LiGeTi(PO₄)₃, LiGe₂(PO₄)₃, LiHf₂ (PO₄)₃, and combinations thereof. The Perovskite-type ceramics may be selected from the group consisting of: Li_{3.3}La_{0.53} TiO₃, LiSr_{1.65}Zr_{1.3} Ta_{1.7}O₉, Li_{7x-y}Sr₁₋ₓTa_{y}Zr₁-O₃ (where x=0.75y and 0.60<y<0.75), Li_{3/8}ST_{7/16}Nb_{3/4}Zr_{1/4}O₃, LixLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{y}P_{3-y}O₁₂ (where 0<x<2 and 0)<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₇S-P₂S₅ systems (such as, Li₃PS₄, Li₇P₃S₁₁, and Li_{9.6}P₃S₁₂), Li₇S-SnS₂ systems (such as, Li₄SnS₄), Li₇S-SiS₂ systems, Li₇S-GeS₂ systems, Li₇S-B₂S₃ systems, Li₇S-Ga₂S₃system, Li₇S-P₂S₃ systems, Li₇S-Al₂S₃ systems, Li_{3.4}Si_{0.4}P_{0.6}S₄, Li₁₀GeP₂S_{11.700.3}, lithium argyrodite Li₆PS₅X (where X is one of Cl, Br, and I). Example pseudoternary sulfide systems include Li₇O-Li₇S-P₂S₅systems, Li₇S-P₂S₅-P₂O₅ systems, Li₇S-P₂S₅-GeS₂ systems (such as, Li_{3.25}Ge_{0.25}P_{0.75}S₄ (thio-LISICON) and Li₁₀GeP₂S₁₂(LGPS)), Li₇S-P₂S₅-LiX systems (where X is one of F, Cl, Br, and I) (such as, Li₆PS₅Br, Li₆PS₅Cl, L₇P₂S₈I, and Li₄PS₄I), Li₇S-As₂S₅-SnS₂ systems (such as, Li_{3.833}Sn_{0.833}As_{0.166}S₄), Li₇S-P₂S₅-A₁₂S₃ systems, Li₇S-LiX-SiS₂ systems (where X is one of F, Cl, Br, and I), 0.4LiI·0.6Li₄SnS₄, and LinSi₂PS₁₂. Example pseudoquaternary sulfide systems include Li₂O-Li₂S-P₂S₅-P₂O₅ systems, Li_{9.54}Si_{1.74}P_{1.44}S_{11.7}Cl_{0.3}, Li_{9.6}P₃S₁₂, Li₇P₃S₁₁, LigP₃S₉₀₃, Li_{10.35}Ge_{1.35}P_{1.65}S₁₂, Li_{10.35}Si_{1.35}P_{1.65}S₁₂, Li_{9.81}Sn_{0.81}P_{2.1.9}S₁₂, Li₁₀(Si_{0.5}Ge_{0.5})P₂S₁₂, Li₁₀(Ge_{0.5}Sne_{0.5}) P₂S₁₂, Li₁₀ (Si_{0.5}Sn_{0.5}) P₂S₁₂, Li₇P_{2.9}Mn_{0.1}S_{10.7}I_{0.3}, Li_{3.833}Sn_{0.833} As_{0.166}S₄, LiI-Li₄SnS₄, Li₄SnS₄, and Li_{10.35[}Sn_{0.27}Si_{1.08]}P_{1.65}S₁₂.

In certain variations, the inactive oxide particles may include, for example only, SiO₂, Al₂O₃, TiO₂, ZrO₂, and combinations thereof: the nitride-based particles may include, for example only, Li₃N, Li-PN₄, LiSi₂N₃, and combinations thereof; the hydride-based particles may include, for example only, LiBH₄, LiBH₄-LiX (where X=Cl, Br, or I), LiNH₂, Li₇NH, LiBH₄-LiNH₂, Li₃AlH₆, and combinations thereof: the halide-based particles may include, for example only, Lil, Li₃InCl₆, Li₇CdCl₄, Li₂MgCl₄, LiCdI₄, Li₇ZnI₄, Li₃OCl, Li₃YCl₆, Li₃YBr₆, and combinations thereof; and the borate-based particles may include, for example only, Li₂B₄₀₇, Li₂O-B₂O₃-P₂O₅, and combinations thereof.

### C. Current Collectors

The positive electrode current collector 34 and/or the negative electrode current collector 32 may include at least one of stainless steel, aluminum, nickel, iron, titanium, copper, tin, or any other electrically conductive material known to those of skill in the art. Additionally or alternatively, the positive electrode current collector 34 and/or the negative electrode current collector 32 may also be a cladded foil, for example, where one side (e.g., the first side or the second side) of the current collector 32, 34 includes one metal (e.g., first metal) and another side (e.g., the other side of the first side or the second side) of the current collector 32, 34 includes another metal (e.g., second metal). The cladded foil may include, for example only, aluminum-copper (Al-Cu), nickel-copper (Ni-Cu), stainless steel-copper (SS-Cu), aluminum-nickel (Al-Ni), aluminum-stainless steel (Al-SS), and nickel-stainless steel (Ni-SS). In certain variations, the positive electrode current collector 34 and/or the negative electrode current collector 32 may be pre-coated, such as graphene or carbon-coated aluminum current collectors. In certain aspects, the positive electrode current collector 34 and/or negative electrode current collector 32 may be in the form of a foil, slit mesh, and/or woven mesh.

### D. Electrolyte Layer

As illustrated in FIGS. 2A and 2B, an electrolyte layer 26 including the polymeric gel electrolyte 30 as described herein may be disposed within the battery 20 between the negative electrode 22 and the positive electrode 24. Referring to FIG. 2A, the polymeric gel electrolyte 30 may be present within the pores of separator 38 and between the negative electroactive particles 33 and/or the positive electroactive particles 35, for example, in the void spaces between particles. Additionally or alternatively, as illustrated in FIG. 2B, in battery 21 the electrolyte layer 26 may include a plurality of solid-state electrolyte particles 36 as described herein. For example, the solid-state electrolyte particles 36 may comprise one or more oxide-based particles, sulfide-based particles, metal-doped or aliovalent-substituted oxide particles, inactive oxide particles, nitride-based particles, hydride-based particles, halide-based particles, and borate-based particles, all as described herein. In such instances, the polymeric gel electrolyte 30 may be present between one or more of the solid-state electrolyte particles 36, the negative electroactive particles 33, and the positive electroactive particles 35, for example, in the void spaces between particles. In certain variations, the battery 20, 21 may include greater than or equal to about 0.5 wt. % to less than or equal to about 50 wt. %, and in certain aspects, optionally greater than or equal to about 5wt. % to less than or equal to about 35 wt. %, of the polymeric gel electrolyte 30.

Although it appears that there are no pores or voids remaining in the illustrated figure, some porosity may remain between adjacent particles (including, for example only, between the solid-state electrolyte particles 36 and/or between the negative electroactive particles 33 and/or between the positive electroactive particles 35) depending on the penetration of the polymeric gel electrolyte 30. For example, a battery 20 including the polymeric gel electrolyte 30 may have a porosity less than or equal to about 50 volume percent (vol. %), and in certain aspects, optionally less than or equal to about 30 vol. %.

### E. Separator

When present, the separator 38 may comprise, for example, a microporous polymeric separator comprising a polyolefin or PTFE. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP, for example a PP-PE dual layer structure or PP-PE-PP three-layer structure. Commercially available polyolefin porous separator membranes include CELGARDR 2500 (a monolayer polypropylene separator) and CELGARD″ 2325 (a trilayer polypropylene/polyethylene/polypropylene separator) available from Celgard LLC.

In certain aspects, the separator 38 may further include one or more of a ceramic coating layer and a heat-resistant material coating. The ceramic coating layer and/or the heat-resistant material coating may be disposed on one or more sides of the separator 38. The material forming the ceramic layer may be selected from the group consisting of: alumina (Al₂O₃), silica (SiO₂), titania (TiO₂), and combinations thereof. The heat-resistant material may be selected from the group consisting of: Nomex, Aramid, and combinations thereof.

When the separator 38 is a microporous polymeric separator, it may be a single layer or a multi-layer laminate, which may be fabricated from either a dry or a wet process. For example, in certain instances, a single layer of the polyolefin may form the entire separator 38. In other aspects, the separator 38 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 38. The separator 38 may also comprise other polymers in addition to the polyolefin such as, but not limited to, polyethylene terephthalate (PET), polyvinylidene fluoride (PVDF), a polyamide, polyimide, poly(amide-imide) copolymer, polyetherimide, and/or cellulose, or any other material suitable for creating the required porous structure. In certain variations, the separator 38 may comprise a cellulose separator, a PVDF membrane, and a porous polyimide membrane.

The polyolefin layer, and any other optional polymer layers, may further be included in the separator 38 as a fibrous layer to help provide the separator 38 with appropriate structural and porosity characteristics. Various conventionally available polymers and commercial products for forming the separator 38 are contemplated, as well as the many manufacturing methods that may be employed to produce such a microporous polymer separator 38. In certain variations, the polymeric gel electrolyte may wet (e.g., fill, 5% to 100%, for example, 90%, of the porosity of) the separator.

The separator 38 may also comprise high temperature stable polymer, such as, but not limited to, polyimide nanofiber-based nonwovens, nano-sized Al₂O₃ and poly(lithium 4-styrenesulfonate)-coated polyethylene membrane, SiO₂ coated polyethylene, co-polyimide-coated polyethylene, polyetherimides (PEI) bisphenol-acetone diphthalic anhydride (BPADA) and para-phenylenediamine, expanded polytetrafluoroethylene reinforced polyvinylidenefluoride-hexafluoropropylene, and so on. In certain variations, the separator 38 may be high temperature stable separator and comprise a sandwich-structured PVDF/poly(m-phenylene isophthalamide) (PMIA)/PVDF nanofibrous separator.

The polymeric gel electrolyte may replace a liquid electrolyte in a lithium-ion battery cell. For example, a cell may include a cathode layer, a silicon anode layer (e.g., columnar silicon), a separating layer between the cathode layer and the silicon anode layer, the separating layer including a (polymer-based) separator (see FIG. 2A), and a current collector for each of the cathode layer and the silicon anode layer. The polymeric gel electrolyte may be present all the layers (e.g., the cathode layer, the silicon anode layer, and the separating layer).

The polymeric gel electrolyte may be used to wet particle-particle interfaces in an SSB to enhance cell performance. For example, a cell may include a cathode layer, solid-state electrolyte particles within the cathode layer, a silicon anode layer, a separating layer between the cathode layer and the silicon anode layer, the separating layer including a solid electrolyte layer including solid-state electrolyte particles (see FIG. 2B) and optionally a (polymer-based) separator, and a current collector for each of the cathode layer and the silicon anode layer. The polymeric gel electrolyte may be present all the layers (e.g., the cathode layer, the silicon anode layer, and the separating layer). In certain variations, the polymeric gel electrolyte may wet, e.g., fill, 5% to 100%, for example, 80%, of the porosity of the solid electrolyte layer including solid-state electrolyte particles.

### EXAMPLES

Pouch cells were fabricated, for example, as depicted in FIG. 2B, with a LiMn_{0.7}Fe_{0.3}PO₄ and LiMn₂O₄ blend cathode, a Li₇La₃Zr₂O₁₂ (LLZO) solid electrolyte layer, and a silicon anode (1 milliampere-hours per square centimeter (mAh/cm²)). The polymeric gel electrolytes prepared included 95 weight percent (wt. %) of a combination of 0.8 molar (moles per liter (M)) bis(trifluoromethanesulfonyl)imide (LiTFSI), 0.8 M lithium tetrafluoroborate (LiBF₄), and plasticizers+5 wt. % polyvinylidene fluoride-hexafluoropropylene (PVDF-HFP). Details of the plasticizers are as follows:

TABLE 1

| | Fluoroethylene | γ-butyro- | Ethylene | |
|---|---|---|---|---|
| | carbonate | lactone | carbonate | |
| | (FEC) | (GBL) | (EC) | Weight Ratio |
| Comparative | x | ✓ | ✓ | EC:GBL = 3:7 |
| Example 1 | | | | |
| Comparative | ✓ | ✓ | ✓ | EC:FEC:GBL = |
| Example 2 | | | | 1.5:1.5:7 |
| Example 1 | ✓ | ✓ | x | FEC:GBL = 3:7 |
| Example 2 | ✓ | ✓ | x | FEC:GBL = 5:5 |

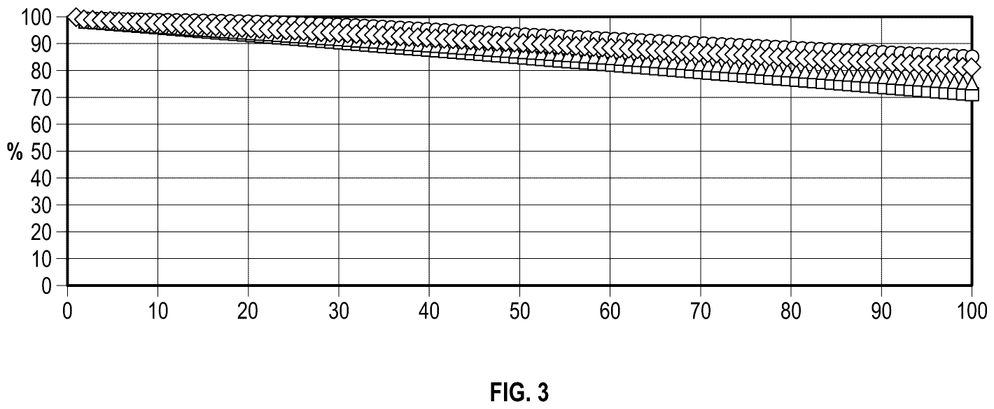

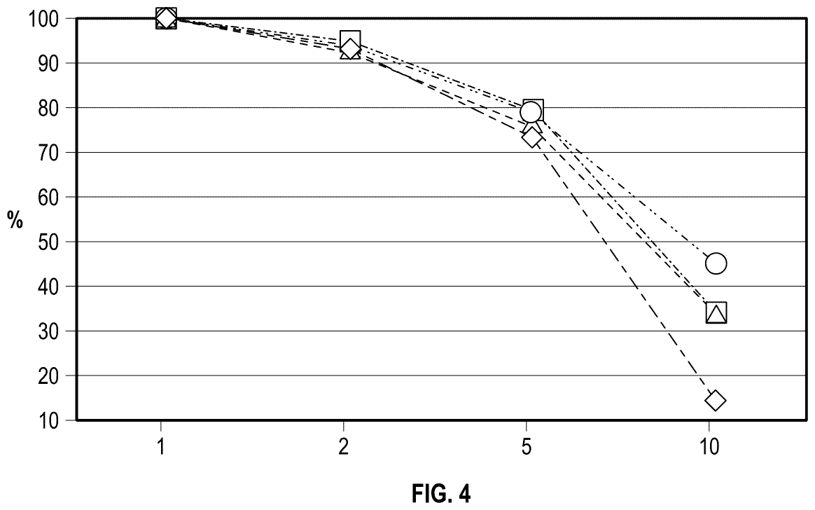

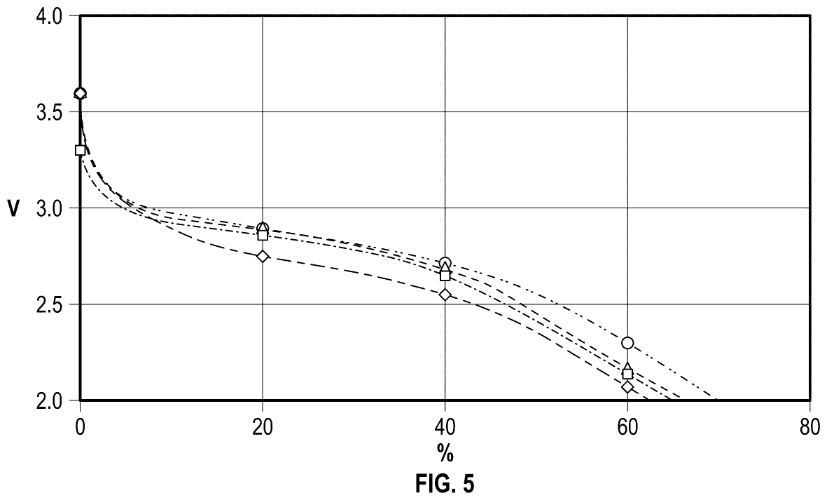

Pouch cell performance at lower (e.g., −18° C.) and higher (e.g., 45° C.) temperatures was tested and the results are shown in FIGS. 3-9. In FIGS. 3-5, Comparative Example 1 data points are represented by squares, Comparative Example 2 data points are represented by triangles, Example 1 data points are represented by circles, and Example 2 data points are represented by diamonds. In FIG. 3, the x-axis represents 45° C. high-temperature cycle number and the y-axis represents capacity retention (%). As shown in FIG. 3, the polymeric gel electrolytes of especially Example 1 enabled a desirable capacity retention. Rapid capacity fading of Comparative Example 1 may be related to irreversible consumption of Li⁺ ions. Without wishing to be bound by any theory, it is believed that the gel-enabled solid electrolyte interphase (SEI) film on silicon may be repeatedly destroyed and re-formed under the influence of the silicon volumetric expansion (greater than 300%). In FIG. 4, the x-axis represents the 25° C. temperature discharge rate (wherein 1 represents IC, 2 represents 2C, 5 represents 5C, and 10 represents 10C) and the y-axis represents capacity retention (%). As shown in FIG. 4, the polymeric gel electrolytes of especially Example 1 enabled a desirable 25° C. rate capability. In FIG. 5, the x-axis represents capacity retention (%) and the y-axis represents the −18° C. cold-cranking voltage (V) (voltage at 2 second pulses) of the pouch cell after high-temperature cycles. As shown in FIG. 5, the polymeric gel electrolytes of especially Example 1 enabled a desirable-18° C. discharge.

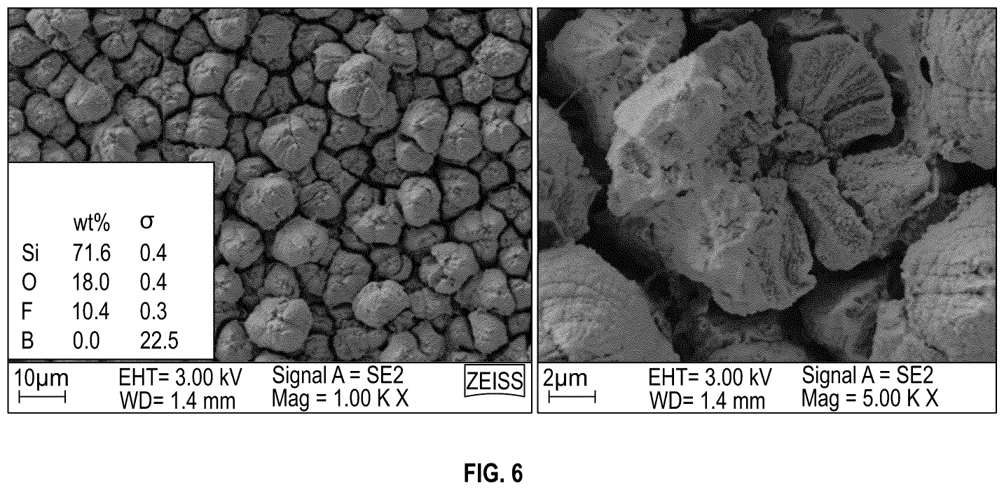

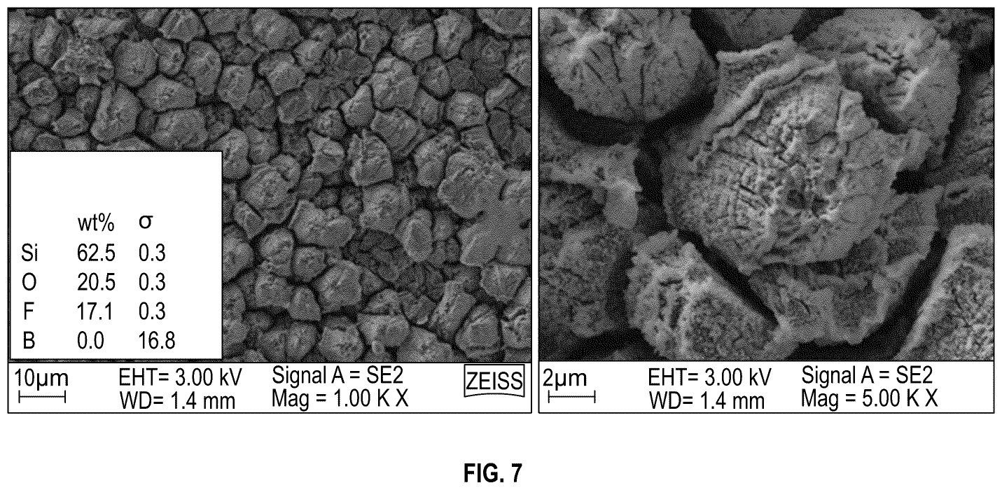

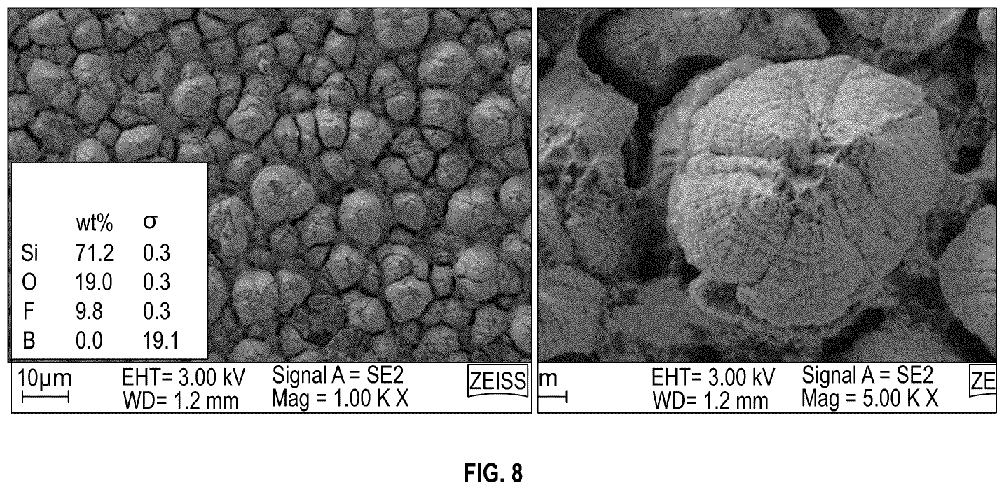

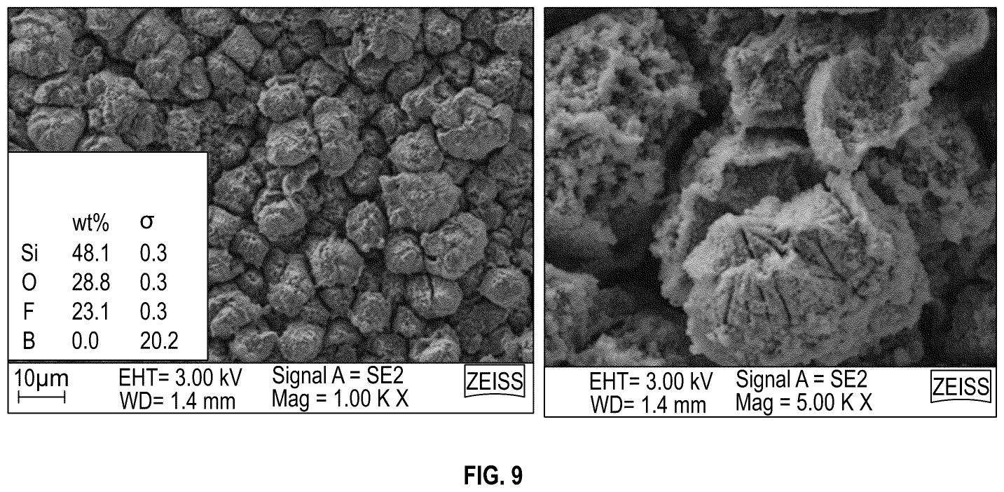

FIGS. 6-9 are scanning electron microscope (SEM) images of the silicon anodes of Comparative Example, 1, Comparative Example 2, Example 1, and Example 2, respectively, after testing at 45° C. for 100 cycles. Example 1 (FIG. 8) showed no obvious cracking of silicon particles, meaning a relatively robust solid electrolyte interphase (SEI) was formed. Comparative Examples 1 and 2 (FIGS. 6 and 7, respectively) showed pulverization of silicon particles with a high fluorine content on a surface thereof, perhaps, and without wishing to be bound by any theory, due to decomposition of gel electrolyte and SEI re-formation. Without wishing to be bound by any theory, it is believed that Example 2 (FIG. 9) may provide more desirable results with silicon particles having a greater surface area.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A polymeric gel electrolyte for an electrochemical cell, wherein the polymeric gel electrolyte comprises:
a lithium salt comprising sulfur and fluorine;
a lithium salt comprising boron;
a fluorinated plasticizer;
a non-fluorinated plasticizer; and
a polymeric host,
wherein a w/w ratio of the fluorinated plasticizer to the non-fluorinated plasticizer is 9:1 to 1:9.

2. The polymeric gel electrolyte of claim 1, wherein each of the lithium salt comprising sulfur and fluorine and the lithium salt comprising boron has a concentration of greater than or equal to about 0.6 M to less than or equal to about 2 M.

3. The polymeric gel electrolyte of claim 1, wherein:
the lithium salt comprising sulfur and fluorine comprises a lithium cation (Li⁺) and an anion selected from the group consisting of bis-trifluoromethanesulfonimide (TFSI⁻), bis(fluorosulfonyl)imide (FSI⁻), trifluoromethanesulfonate (triflate⁻) bis(pentafluoroethanesulfonyl)imide (BETI⁻), cyclo-difluoromethane-1,1-bis(sulfonyl)imide (DMSI⁻), cyclo-hexafluoropropane-1,1-bis(sulfonyl)imide (HPSI⁻), and a combination thereof; and
the lithium salt comprising boron comprises a lithium cation (Li⁺) and an anion selected from the group consisting of tetrafluoroborate (BF₄⁻), bis(oxaloto)borate (BOB⁻), tetracyanoborate (bison⁻), difluoro(oxalate)borate (DFOB⁻), bis(fluoromalonato)borate (BFMB⁻), and a combination thereof.

4. The polymeric gel electrolyte of claim 1, wherein:
the fluorinated plasticizer comprises fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethylmethylcarbonate, 2,2-difluoroethylethylethylcarbonate, 2,2-difluoroethylacetate, 2,2,2-trifluoroethylacetate, 1,1,2,2-tatrafluoroethyl 2,2,3,3-tetrafluoropropyl ether, or a combination thereof; and
the non-fluorinated plasticizer comprises γ-butyrolactone (GBL), propylene carbonate (PC), glycerol carbonate, vinylene carbonate, 1,2-butylene carbonate, δ-valerolactone, succinonitrile, glutaronitrile adiponitrile, tetramethylene sulfone, ethyl methyl sulfone, vinyl sulfone, phenyl sulfone, benzyl sulfone, triethylene glycol dimethylether, tetraethylene glycol dimethylether, 1,3-dimethoxy propane, 1,4-dioxane, triethyl phosphate, trimethyl phosphate, or a combination thereof.

5. The polymeric gel electrolyte of claim 1, wherein:
the lithium salt comprising sulfur and fluorine comprises lithium bis(trifluoromethanesulfonyl)imide (LiTFSI);
the lithium salt comprising boron comprises lithium tetrafluoroborate (LiBF₄);
the fluorinated plasticizer comprises fluoroethylene carbonate (FEC);
the non-fluorinated plasticizer comprises γ-butyrolactone (GBL); and
the polymeric host comprises polyvinylidene fluoride-hexafluoropropylene (PVDF-HFP).

6. The polymeric gel electrolyte of claim 1, wherein the polymeric host is selected from the group consisting of: polyvinylidene fluoride (PVDF), polyvinylidene fluoride-hexafluoropropylene (PVDF-HFP), polyethylene oxide (PEO), poly(acrylic acid) (PAA), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

7. The polymeric gel electrolyte of claim 1, wherein one or more of the following are satisfied:
(i) a combination of the lithium salt comprising sulfur and fluorine and the lithium salt comprising boron has a concentration of greater than or equal to about 1.2 M to less than or equal to about 4 M;
(ii) each of the lithium salt comprising sulfur and fluorine and the lithium salt comprising boron has a concentration of greater than or equal to about 0.6 M to less than or equal to about 2 M;
(iii) the w/w ratio of the fluorinated plasticizer to the non-fluorinated plasticizer is about 0.9:1 w/w to about 0.2:1 w/w; and
(iv) the polymer host is present in an amount of 0.5 wt. % to about 40 wt. %.

8. The polymeric gel electrolyte of claim 1, wherein one or more of the following are satisfied:
(i) the lithium salt comprising sulfur and fluorine comprises lithium bis(trifluoromethanesulfonyl)imide (LiTFSI);
(ii) the lithium salt comprising boron comprises lithium tetrafluoroborate (LiBF₄);
(iii) the fluorinated plasticizer comprises fluoroethylene carbonate (FEC);
(iv) the non-fluorinated plasticizer comprises γ-butyrolactone (GBL); and
(v) the polymeric host comprises polyvinylidene fluoride-hexafluoropropylene (PVDF-HFP).

9. The polymeric gel electrolyte of claim 1, further comprising solid-state electrolyte particles.

10. An electrochemical cell that cycles lithium ions, the electrochemical cell comprising:
a first electrode comprising a first electroactive material;
a second electrode comprising a second electroactive material; and
an electrolyte layer disposed between the first electrode and the second electrode, wherein at least one of the first electrode, the second electrode, and the electrolyte layer comprises a polymeric gel electrolyte comprising:
a lithium salt comprising sulfur and fluorine;
a lithium salt comprising boron;
a fluorinated plasticizer;
a non-fluorinated plasticizer; and
a polymeric host.

11. The electrochemical cell of claim 10, wherein the electrolyte layer comprises:
a plurality of solid-state electrolyte particles and the polymeric gel electrolyte at least partially fills void spaces between the solid-state electrolyte particles.

12. The electrochemical cell of claim 10, wherein the electrolyte layer further comprises a separator, wherein the gel polymer electrolyte polymeric gel electrolyte at least partially fills void spaces in the separator.

13. The electrochemical cell of claim 10, wherein:
the first electroactive material is selected from the group consisting of Li₍₁₊ₓ₎Mn₂O₄, where 0.1≤x≤1; LiMn₂₋ₓ₎NiₓO₄, where 0≤x≤0.5; LiCoO₂;
Li(NixMnyCoz) O₂, where 0≤x≤1, 0≤y≤1, 0≤z≤1, and x+y+z=1; LiNi_{(1-x-y)} Cox MyO₂, where 0<x<0.2, y<0.2, and M is Al, Mg, or Ti; LiFePO₄, LiMn2-xFex PO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤ 1, 0≤p≤1, x+y+z+p=1 (NCMA); LiNiMnCoO₂; Li₇FeₓM₁₋ₓPO₄, where M is Mn and/or Ni, 0≤x≤1; LiMn₂O₄ (LMO); LiFeSiO₄; LiNi_{0.6}Mn_{0.2}Co0.2O₂ (NMC622), LiMnO₂, LiNi_{0.5}, Mn1.5O₄, LiV₂(PO₄)₃, activated carbon, sulfur, and a combination thereof; and
the second electroactive material comprises metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, iron sulfide (FeS), Li₄Ti₅O₁₂, or a combination thereof.

14. The electrochemical cell of claim 10, wherein one or more of the following are satisfied:
(i) a combination of the lithium salt including sulfur and fluorine and the lithium salt including boron has a concentration of greater than or equal to about 1 M to less than or equal to about 4 M; and
(ii) each of the lithium salt comprising sulfur and fluorine and the lithium salt comprising boron has a concentration of greater than or equal to about 0.6 M to less than or equal to about 2 M.

15. The electrochemical cell of claim 10, wherein:
the lithium salt comprising sulfur and fluorine comprises a lithium cation (Li⁺) and an anion selected from the group consisting of bis-trifluoromethanesulfonimide (TFSI⁻), bis(fluorosulfonyl)imide (FSI⁻), trifluoromethanesulfonate (triflate⁻) bis(pentafluoroethanesulfonyl)imide (BETI⁻), cyclo-difluoromethane-1,1-bis(sulfonyl)imide (DMSI⁻), cyclo-hexafluoropropane-1,1-bis(sulfonyl)imide (HPSI⁻), and a combination thereof; and
the lithium salt comprising boron comprises a lithium cation (Li⁺) and an anion selected from the group consisting of tetrafluoroborate (BF₄⁻), bis(oxaloto)borate (BOB⁻), tetracyanoborate (bison-), difluoro(oxalate)borate (DFOB⁻), bis(fluoromalonato)borate (BFMB⁻), and a combination thereof.

16. The electrochemical cell of claim 10, wherein;
the fluorinated plasticizer comprises fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethylmethylcarbonate, 2,2-difluoroethylethylethylcarbonate, 2,2-difluoroethylacetate, 2,2,2-trifluoroethylacetate, 1,1,2,2-tatrafluoroethyl 2,2,3,3-tetrafluoropropyl ether, or a combination thereof; and
the non-fluorinated plasticizer comprises γ-butyrolactone (GBL), propylene carbonate (PC), glycerol carbonate, vinylene carbonate, 1,2-butylene carbonate, δ-valerolactone, succinonitrile, glutaronitrile adiponitrile, tetramethylene sulfone, ethyl methyl sulfone, vinyl sulfone, phenyl sulfone, benzyl sulfone, triethylene glycol dimethylether, tetraethylene glycol dimethylether, 1,3-dimethoxy propane, 1,4-dioxane, triethyl phosphate, trimethyl phosphate, or a combination thereof.

17. The electrochemical cell of claim 10, wherein:
the lithium salt comprising sulfur and fluorine comprises lithium bis(trifluoromethanesulfonyl)imide (LiTFSI);
the lithium salt comprising boron comprises lithium tetrafluoroborate (LiBF₄);
the fluorinated plasticizer comprises fluoroethylene carbonate (FEC);
the non-fluorinated plasticizer comprises γ-butyrolactone (GBL); and
the polymeric host comprises polyvinylidene fluoride-hexafluoropropylene (PVDF-HFP).

18. The electrochemical cell of claim 10, wherein the polymeric host is selected from the group consisting of: polyvinylidene fluoride (PVDF), polyvinylidene fluoride-hexafluoropropylene (PVDF-HFP), polyethylene oxide (PEO), poly(acrylic acid) (PAA), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

19. The electrochemical cell of claim 10, wherein one or more of the following are satisfied:
(i) a combination of the lithium salt comprising sulfur and fluorine and the lithium salt comprising boron has a concentration of greater than or equal to about 1.2 M to less than or equal to about 4 M;
(ii) each of the lithium salt comprising sulfur and fluorine and the lithium salt comprising boron has a concentration of greater than or equal to about 0.6 M to less than or equal to about 2 M;
(iii) a w/w ratio of the fluorinated plasticizer to the non-fluorinated plasticizer is about 0.9:1 w/w to about 0.2:1 w/w; and
(iv) the polymer host is present in an amount of 0.5 wt. % to about 40 wt. %.

20. The electrochemical cell of claim 10, wherein one or more of the following are satisfied:
(i) the lithium salt comprising sulfur and fluorine comprises lithium bis(trifluoromethanesulfonyl)imide (LiTFSI);
(ii) the lithium salt comprising boron comprises lithium tetrafluoroborate (LiBF₄);
(iii) the fluorinated plasticizer comprises fluoroethylene carbonate (FEC);
(iv) the non-fluorinated plasticizer comprises γ-butyrolactone (GBL); and
(v) the polymeric host comprises polyvinylidene fluoride-hexafluoropropylene (PVDF-HFP).
